(19) United States
(12) Patent Application Publication
(10) Pub. No.: US 2014/0304967 A1
(43) Pub. Date: Oct. 16, 2014

(54) BLANKET FOR TUBULAR OBJECTS

(71) Applicant: Chad S. CRAIK, Grande Prairie (CA)

(72) Inventor: Chad S. CRAIK, Grande Prairie (CA)

(21) Appl. No.: 14/254,357

(22) Filed: Apr. 16, 2014

(30) Foreign Application Priority Data
Apr. 16, 2013 (CA) 2812780

(51) Int. Cl. B23K 37/00; B23K 37/06

(52) U.S. Cl. CPC B23K 37/00; B23K 37/06
USPC 29/428; 428/174

(57) ABSTRACT

A blanket for tubular objects includes a sheet of flexible blanket material and two or more parallel spaced spring band ribs reinforcing the blanket material. Each spring band rib being arcuate in cross section with a convex surface and a concave surface. The arcuate cross section maintains each spring band rib in a normally straight position until the convex surface of the spring band rib is subjected to a force transverse to a length of the spring band rib triggering a spring action which causes the spring band rib to assume a circular orientation.

### FIELD

A blanket will hereinafter be described which was developed as a welding blanket to be placed over fresh welds on pipe, it will be appreciated that this blanket may be used with any tubular objects and is not restricted for use when welding.

### BACKGROUND

When welding outdoors, welding blankets are placed over fresh welds to allow the welds to cool slowly and protect them from rain, snow and other elements which might adversely affect the quality of the weld. Welding blankets are currently attached to the pipe using fabric ties. There will hereinafter be described a blanket for tubular objects that can be quickly and easily placed in position.

### SUMMARY

There is provided a blanket for tubular objects that includes a sheet of flexible blanket material and two or more parallel spaced spring band ribs reinforcing the blanket material. Each spring band rib is arcuate in cross-section with as convex surface and a concave surface. The arcuate cross-section maintains each spring band rib in a normally straight position until the convex surface of the spring band rib is subjected to a force transverse to a length of the spring band rib. The force triggers a spring action which causes the spring band rib to assume a circular orientation.

In a preferred embodiment, the flexible blanket material is heat resistant for use over fresh welds. A non-heat resistant fabric may be damaged by use on fresh welds.

There is provided a method of positioning a welding blanket over a fresh weld that includes providing a welding blanket. The welding blanket has a sheet of heat resistant flexible blanket material and two or more parallel spaced spring band ribs reinforcing the blanket material. Each spring band rib is arcuate in cross-section with a convex surface and a concave surface. The arcuate cross-section maintains each spring band rib in a normally straight position until the convex surface of the spring band rib is subjected to a force transverse to a length of the spring band rib. This triggers a spring action which causes the spring band rib to assume a circular orientation. The blanket material is positioned in spaced relation to a fresh weld on a pipe with each spring band rib in a straight orientation. Blanket material is urged against the pipe with the pipe exerting a force against the convex surface of each spring band which is transverse to the length of each spring band rib. This causes each spring band rib to assume a circular orientation wrapped around the pipe.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top perspective view of a welding blanket positioned over a fresh weld on a pipe, with blanket shown in dotted lines to reveal internal spring band rib structure.

FIG. 2 is a top perspective view of the welding blanket wrapped around the pipe of FIG. 1, with internal spring band rib structure shown in dotted lines.

FIG. 3 is a detailed perspective view showing cross section detail of the spring band rib illustrated in FIG. 1 and FIG. 2.

### DETAILED DESCRIPTION

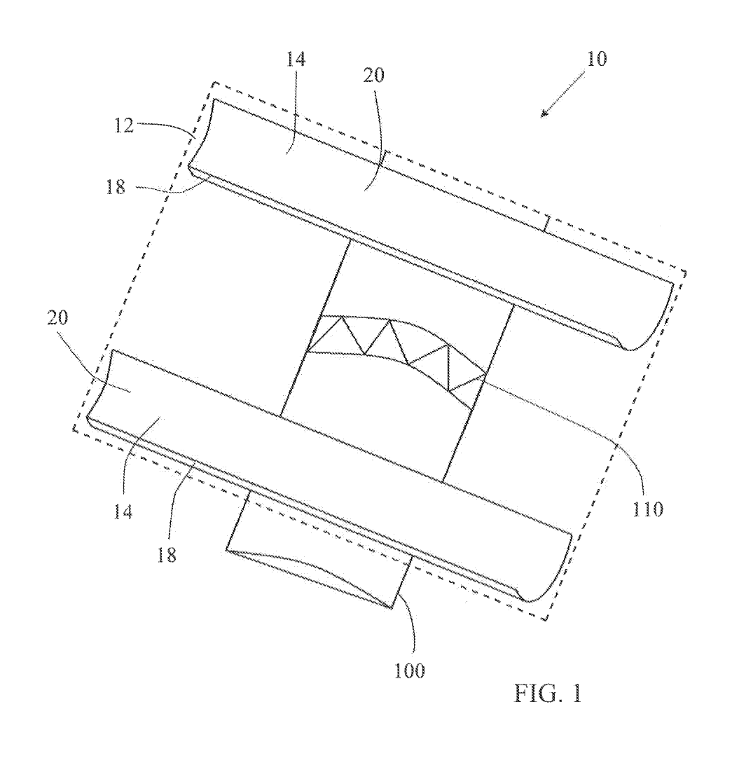

A blanket for tubular objects generally identified by reference numeral 10, will now be described with reference to FIG. 1 through 3.

### Structure and Relationship of Parts

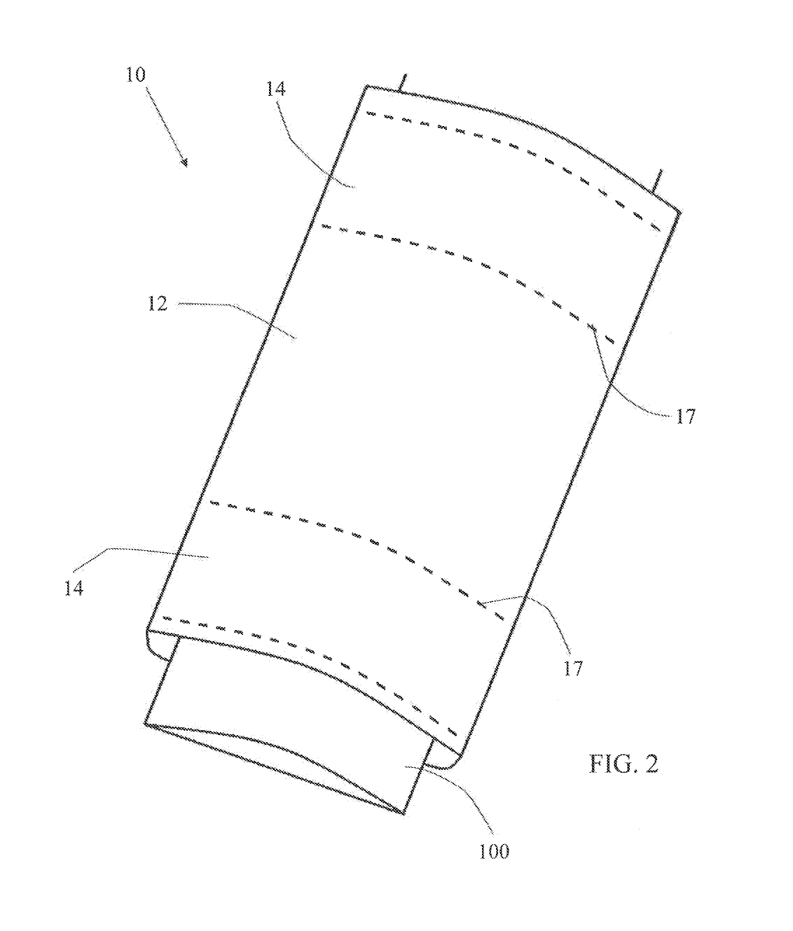

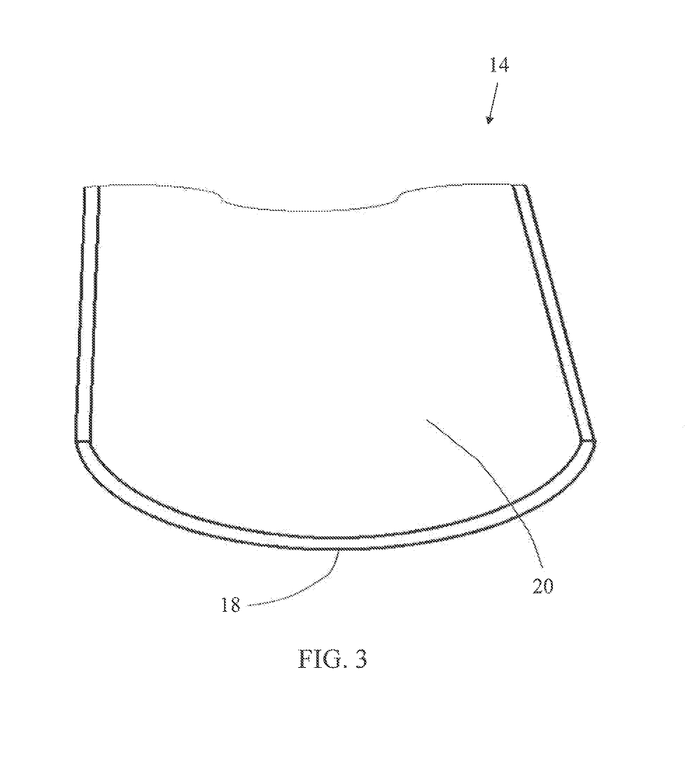

Referring to FIG. 1, blanket 10 includes a sheet of flexible blanket material 12 and two or more parallel spaced spring band ribs 14. For welding blanket applications, it is preferable that flexible blanket material 12 be a heat resistant material which will not be damaged when placed over fresh welds. Referring to FIG. 3, each spring band rib 14 is arcuate in cross-section with a convex surface 18 and a concave surface 20. Referring to FIG. 2, spring band 16 is preferably held in place in an internal pocket 17 formed in blanket material 12. This prevents excessive movement of spring band rib 14 in blanket 10. Referring to FIG. 1, the arcuate cross-section maintains spring band rib 14 in a normally straight position until convex surface 18 of spring band rib 14 is subjected to a force transverse to a length of spring band rib 14. Referring to FIG. 2, this triggers a spring action which causes spring band rib 14 to assume a circular orientation.

### Operation

Referring to FIG. 1, blanket 10 is positioned over a fresh weld 110 to allow it to cool slowly and provide protection from the elements. Blanket material 12 is positioned in spaced relation to fresh weld 110 on a pipe 100 with each spring band rib 14 in a straight orientation and holding blanket material 12 in a straight orientation. Blanket material 12 is urged against pipe 100 with pipe 100 exerting a force against convex surface 18 of spring hand rib 14 which is transverse to the length of each spring band rib 14. Referring to FIG. 2, this causes each spring band rib 14 to assume a circular orientation wrapping blanket 10 around pipe 100.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the preferred embodiments set forth in the examples, but should be given a broad purposive interpretation consistent with the description as a whole.

What is claimed is:

1. A blanket for tubular objects, comprising:
a sheet of flexible blanket material;
two or more parallel spaced spring band ribs reinforcing the blanket material, each spring band rib being arcuate in cross-section with a convex surface and a concave surface, the arcuate cross-section maintaining the spring band rib in a normally straight position until the convex surface of the spring band rib is subjected to a force transverse to a length of the spring band rib triggering a spring action which causes the spring band rib to assume a circular orientation.

2. The blanket of claim 1, wherein the flexible blanket material is heat resistant for use over fresh welds.

3. The blanket of claim 1, wherein each spring band rib is held within a pocket created in the flexible blanket material.

4. A method of positioning a welding blanket over a fresh weld, comprising:
providing a welding blanket comprising:
a sheet of flexible blanket material which is heat resistant;
two or more parallel spaced spring band ribs reinforcing the blanket material, each spring band rib being arcuate in cross-section with a convex surface and a concave surface, the arcuate cross-section maintaining the spring band rib in a normally straight position until the convex surface of the spring hand rib is subjected to a force transverse to a length of the spring band rib triggering a spring action which causes the spring band rib to assume a circular orientation;
positioning the blanket material in spaced relation to a fresh weld on a pipe, with each spring band rib in a straight orientation; and
urging the blanket material against the pipe with the pipe exerting a three against the convex surface of each spring band rib which is transverse to the length of each spring band rib, thereby causing each spring band rib to assume a circular orientation wrapped around the pipe.
